(19) United States
(12) Patent Application Publication
(10) Pub. No.: US 2021/0300263 A1
(43) Pub. Date: Sep. 30, 2021

(54) VEHICULAR DISPLAY SYSTEM WITH ADJUSTABLE MOUNTING OF REAR CAMERA

(71) Applicant: Magna Mirrors of America, Inc., Holland, MI (US)

(72) Inventors: Vernon R. Nise, Caledonia, MI (US); John T. Uken, Jenison, MI (US); Rodney K. Blank, Zeeland, MI (US)

(21) Appl. No.: 17/301,073

(22) Filed: Mar. 24, 2021

Related U.S. Application Data
(60) Provisional application No. 62/994,301, filed on Mar. 25, 2020.

(51) Int. Cl. B60R 11/04; B60R 1/08; H04N 5/225

(52) U.S. Cl. CPC B60R 11/04; B60R 2001/1253; H04N 5/2257; B60R 1/08

(57) ABSTRACT

A vehicular vision system includes an electronic control unit (ECU) disposed at a vehicle, a rear camera disposed at the vehicle and having a field of view at least rearward of the vehicle. The rear camera captures image data and provides captured image data to the ECU. A video display screen is disposed in the vehicle and is viewable by a driver of the vehicle. The video display screen is operable to display video images derived from a video signal provided by the ECU during a forward maneuver of the vehicle. The rear camera is mounted at a camera mounting bracket that is attached at a spare tire mounting bracket at a rear of the vehicle. A height of the rear camera is adjustable to position the rear camera above a spare tire mounted at the spare tire mounting bracket.

### CROSS REFERENCE TO RELATED APPLICATION

The present application claims the filing benefits of U.S. provisional application Ser. No. 62/994,301, filed Mar. 25, 2020, which is hereby incorporated herein by reference in its entirety.

### FIELD OF THE INVENTION

The present invention relates to vehicular vision systems that display video images derived from image data captured by one or more cameras of the vehicle.

### BACKGROUND OF THE INVENTION

It is known to provide a video display at an interior rearview mirror assembly to display sideward and/or rearward images, such as described in U.S. Pat. No. 5,670,935, which is hereby incorporated herein by reference in its entirety.

### SUMMARY OF THE INVENTION

The present invention provides a vehicular vision system that displays video images at a video display screen, such as at an interior rearview mirror assembly or center console or stack, for a camera monitoring system using at least a rearward viewing camera disposed at the vehicle and having a field of view at least rearward of the vehicle. The rear camera is mounted at a camera mounting bracket that mounts to or attaches at a spare tire mounting bracket at the rear of the vehicle. The camera mounting bracket is adjustable to adjust a height of the rear camera to position the rear camera above a spare tire mounted at the spare tire mounting bracket. The camera mounting bracket may adjustably mount to the spare tire mounting bracket or may comprise at least one extendable/retractable arm that extends/retracts to adjust the height of the camera above the spare tire mounted at the spare tire mounting bracket.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle having a vision system and rear camera in accordance with the present invention;

FIG. 2 is a side view of the vehicle of FIG. 1, showing the adjustable rear camera mounting system;

FIG. 3 is a perspective view of the adjustable camera bracket for adjustably mounting the rear camera at the rear of the vehicle;

FIGS. 4 and 5 are side views of the rear camera and adjustable camera mount at the rear of the vehicle;

FIG. 6 is another side view of the rear camera and adjustable camera mount at the rear of the vehicle;

FIG. 7 is a plan view of a spare tire mounting bracket for mounting a spare tire and the adjustable camera mount at the rear of the vehicle; and

FIG. 8 is a rear view of the adjustable camera mount and rear camera as mounted to the spare tire mounting bracket.

### DESCRIPTION OF THE PREFERRED EMBODIMENTS

A vehicular camera monitoring system or display system operates to capture images exterior of the vehicle via at least a rearward viewing camera and may process the captured image data to display images and to detect objects at or near the vehicle and rearward of the vehicle, such as to assist a driver of the vehicle in maneuvering the vehicle in a rearward direction. The system includes an image processor or image processing system that is operable to receive image data from one or more cameras and to provide an output to one or more display devices for displaying video images representative of the captured image data. For example, the vision system may provide a rearview display or a top down or bird's eye or surround view display or the like.

The system provides an adjustable mounting configuration for the rearward viewing camera to accommodate use of the camera at a vehicle (such as a sport utility vehicle or the like) that has a removable top (such as, for example, a Jeep Wrangler or Ford Bronco or other vehicle that has a removable roof/top and/or is manufactured with different roof types). The rearward viewing camera is mounted at the rear portion of the vehicle (and not at the roof or top of the vehicle), such as at a spare tire mounting arrangement at the rear of the vehicle, and is adjustable to allow for adjusting the height and orientation of the camera for the particular vehicle and spare tire mounted at the spare tire mounting arrangement. By providing the rearward viewing camera at the spare tire mounting arrangement, such as at an arm that also supports a center high-mounted stop light (CHMSL), the vehicle user would not have to remove the camera or wiring when changing between a hard top configuration (where the hard top is on the vehicle), a soft top configuration (where a soft top is on the vehicle) and/or a no top configuration.

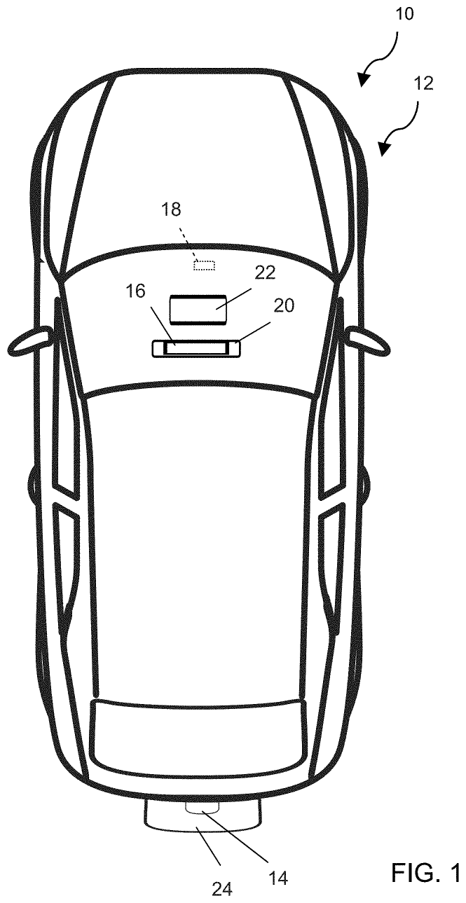

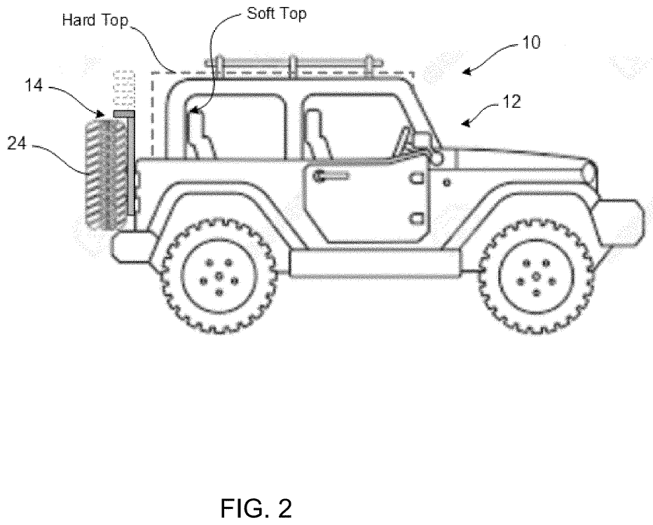

Referring now to the drawings and the illustrative embodiments depicted therein, a vehicle 10 includes a display or vision system 12 that includes a rearward viewing camera 14 for capturing image data for displaying at an interior display screen 22 that is viewable by the driver of the vehicle while operating the vehicle 10 (FIGS. 1 and 2). The vehicle 10 and the display system 12 may include multiple exterior viewing cameras, including, for example, surround view cameras (including a rearward viewing or rear backup camera, a forward viewing camera at the front of the vehicle and side surround view cameras respective sides of the vehicle), camera monitoring system (CMS) cameras (including side rearward viewing CMS cameras at the respective sides of the vehicle, and the rearward viewing camera 14, which has a different field of view than the rear backup camera), which capture image data of the respective scenes exterior of the vehicle 10 and in the field of view of the respective camera, with each camera having a lens for focusing images at or onto an imaging array or imaging plane or imager of the camera (FIG. 1).

The vision system 12 includes a control or electronic control unit (ECU) 18 having electronic circuitry and associated software, with the electronic circuitry including a data processor or image processor that is operable to process image data captured by the cameras, whereby the ECU 18 may detect or determine the presence of objects or the like and/or the ECU 18 may provide video images to a display device 16 of the interior rearview mirror assembly 20 (e.g., a video display screen disposed in the mirror head and behind and viewable through the mirror reflective element of the mirror head) of the vehicle for viewing by the driver of the vehicle and/or to a display device 22 at the center console or stack of the vehicle (and optionally to CMS displays at or near the driver and passenger side A-pillars of the vehicle, such as described in U.S. Publication Nos. US-2018-0134217 and/or US-2014-0285666, which are hereby incorporated herein by reference in their entireties). The data transfer or signal communication from the camera(s) 14 to the ECU 18 may comprise any suitable data or communication link, such as a vehicle network bus or CAN (Controller Area Network) bus or LIN (Local Interconnect Network) bus or I2C bus or the like of the equipped vehicle.

The ECU 18 receives image data captured by each of the cameras 14 and the image data is processed by the data processor or image processor of the ECU. The ECU 18 is connected to the video display 16 of the mirror assembly 20, such as via a single coaxial wire or cable for communicating with the video display 16 (such as to provide control signals or the like) and for providing video image signals to the video display 16, and/or the ECU 18 is connected to the display device 22 of the center console, such as via a single coaxial wire or cable for communicating with the display and for providing video image signals to the display. The system may utilize aspects of the systems described in U.S. patent application Ser. No. 17/248,736, filed Feb. 5, 2021 (Attorney Docket DON01 P4085), which is hereby incorporated herein by reference in its entirety.

For example, the ECU 18 may automatically adjust the output to the video display 16 and/or the display device 22 based on the driving conditions so that the appropriate video images are displayed by the video display 16 and/or the display device 22. In this example, when the vehicle is reversing or parking, the ECU 18 outputs the video image signals to the video display 16. When the vehicle is driving forward during normal driving conditions along a road, the ECU outputs the video image signals to the display device 22. In some implementations, the ECU outputs the video image signals to the video display 16 in the rearview mirror assembly 20 in response to a user input while the vehicle is driven forward along a road.

The interior mirror assembly may comprise a dual-mode interior rearview video mirror that can switch from a traditional reflection mode to a live-video display mode, such as is by utilizing aspects of the mirror assemblies and systems described in U.S. Pat. Nos. 10,442,360; 10,421,404; 10,166,924; 10,046,706 and/or 10,029,614, and/or U.S. Publication Nos. US-2020-0377022; US-2019-0258131; US-2019-0146297; US-2019-0118717; US-2019-0047475 and/or US-2017-0355312, and/or U.S. patent applications Ser. No. 16/949,976, filed Nov. 23, 2020 (Attorney Docket MAG04 P4024), and/or Ser. No. 17/247,127, filed Dec. 1, 2020 (Attorney Docket MAG04 P4043), which are all hereby incorporated herein by reference in their entireties. When in the live-video display mode, the video display screen 16 displays video images derived from video image data captured by the rearward viewing camera 14. The mirror may switch to the live-video display mode responsive to user actuation of a user input at the mirror assembly and while the vehicle 10 is being driven in the forward direction along a road (and optionally during a reversing maneuver of the vehicle 10 if the video images captured by the rear camera 14 are displayed at the display device 22 in the center stack and not at the video display 16 in the rearview mirror).

As shown in FIGS. 1 and 2, the rear camera 14 is mounted at a mounting system at the rear of the vehicle 10 and above a spare tire 24 mounted at a rear door or panel of the vehicle 10. The mounting system thus provides for mounting the rear camera 14 at the vehicle 10 regardless of the type of top or roof provided at the vehicle 10. For vehicles with a soft top, mounting to the roll cage or frame may be beneficial for stability of the camera. However, the soft top requires either a viewing hole for the camera, leading to sealing issues, or an external mounting bracket, which would be covered by the hard top when a hard top is provided. The adjustable height CHMSL 26 and camera bracket allows for any roof system and any wheel/tire combination, as discussed below. A rear backup camera may be provided at the rear of the vehicle 10 and below the rear camera 14, such as at a center region of a spare tire mounting arrangement or at the rear bumper or the like of the vehicle (with the rear backup camera directed rearward and downward as compared to the rear camera 14 such that the field of view of the rear backup camera is immediately rearward of the vehicle while the rear camera 14 views further rearward of the vehicle 10).

The vision system 12 thus may display (e.g. via the video display 16 and/or the display device 22) video images derived from the rear camera 14, such as when the vehicle 10 is traveling forward and the rear display has been selected. The ECU 18 may receive two camera inputs, including a reverse aid input from a rear backup camera positioned at and viewing through the center of the spare tire 24 (for providing rear backup video images during a reversing maneuver of the vehicle 10), and a rear view input from the rear camera 14 located just above the CHMSL 26 (or at or near or adjacent to the CHMSL 26).

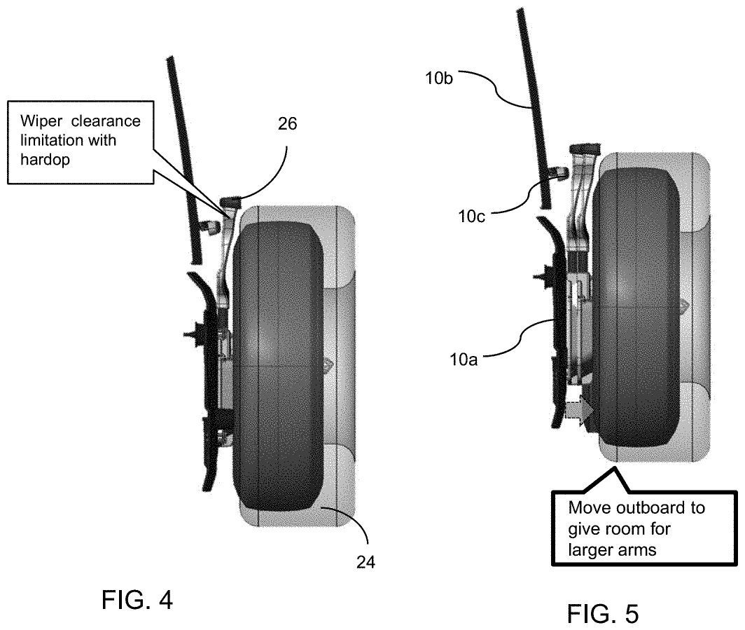

Typically, a vehicle 10 having a hard top/soft top option may have a CHMSL 26 fixedly mounted on a fixed bracket that is fixedly mounted at a rear portion or panel of the vehicle 10 behind the spare tire 24 (see FIG. 4). Such a bracket may be mounted to the mounting bracket for the spare tire 24 that is fastened or bolted to the rear of the vehicle 10. Such a CHMSL bracket supports the CHMSL 26 but, because slight movement of the CHMSL 26 does not affect its operation, such a bracket is not robust or stable enough for mounting the rear camera 24 thereat. In other words, because mounting the rear camera 24 requires stability to ensure clear and quality captured image data, the CHMSL bracket would not be an appropriate bracket to mount the rear camera 14.

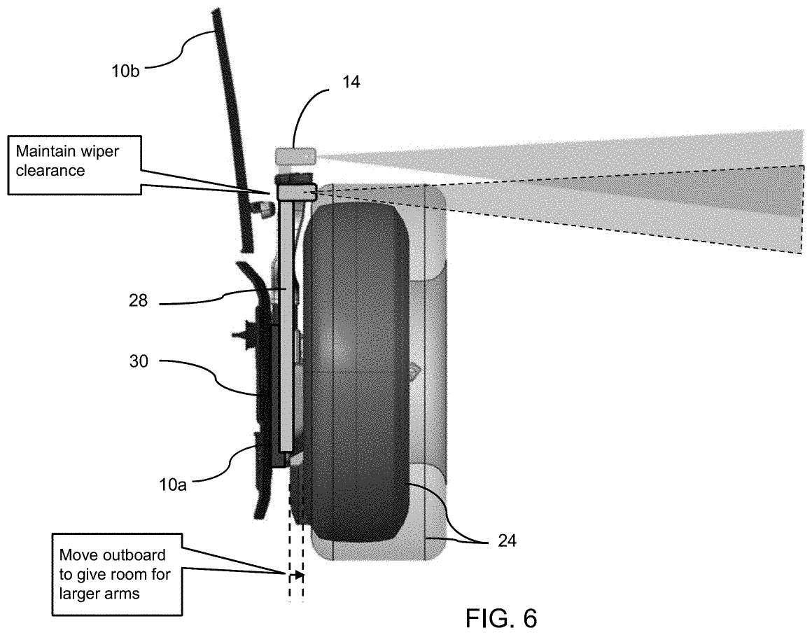

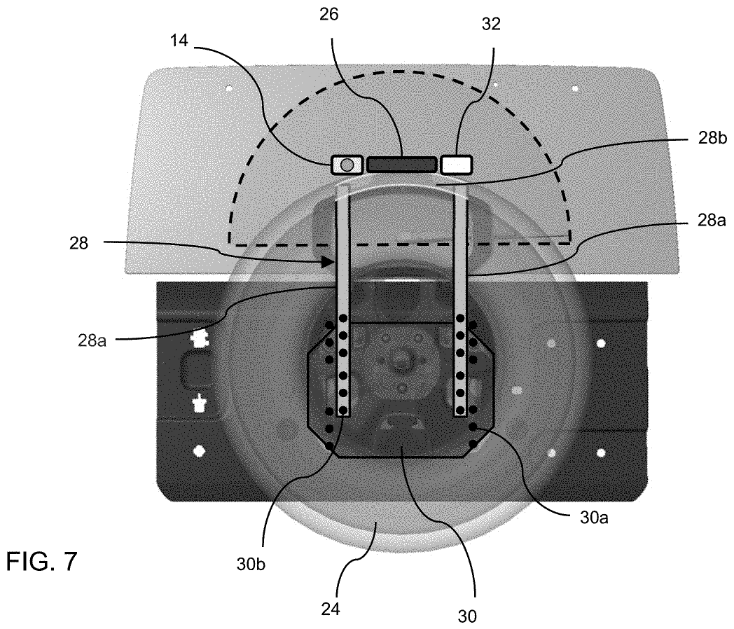

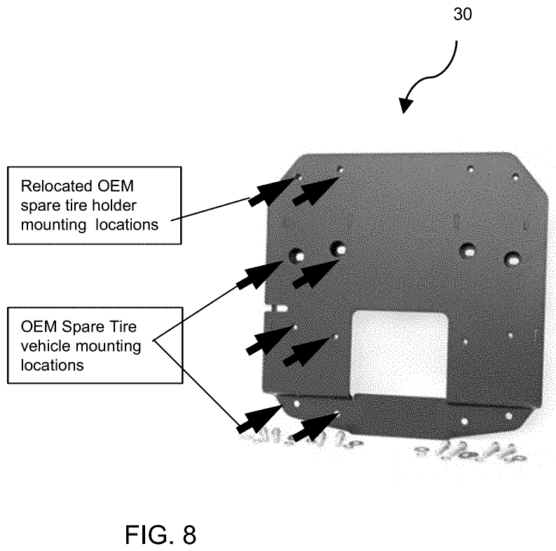

As shown in FIGS. 5-7, the spare tire mounting arrangement is modified to move the spare tire 24 outboard/rearward away from the rear portion or panel 10a of the vehicle to make room for a larger, more robust and more stable camera mounting bracket 28 (FIGS. 6 and 7) that provides clearance between the camera mounting bracket 28 and the rear window wiper 10c at the rear window 10b of the vehicle. As shown in FIG. 7, the camera mounting bracket 28 comprises a pair of vertically oriented structural arms 28a that have their lower ends bolted or fastened to the spare tire bracket 30 (FIG. 8), and that have the rear camera 14 mounted at the upper ends of the vertically oriented structural arms 28a. The bracket 28 may further comprise a crossbar or horizontal element 28b at the upper ends of the vertically oriented structural arms that extends between the upper ends of the vertically oriented structural arms 28a. As shown in FIG. 7, the camera 14 and the CHMSL 26 are disposed at the crossbar element 28b so as to be disposed above the upper extent of the spare tire 24 mounted at the spare tire bracket 30. The vertically oriented structural arms 28a are structurally robust to limit vibration and movement of the camera at the crossbar element 28b during operation of the vehicle. For example, the vertically oriented structural arms 28a are formed via an aluminum die cast forming process.

Optionally, a supplemental or auxiliary illumination source 32 (such as a white light-emitting light emitting diode) may also be disposed at the crossbar element 28b. The auxiliary illumination source 32 may comprise a reverse light (that operates with the reversing lights at the taillights of the vehicle) or may comprise an auxiliary light to illuminate (such as with white light or with infrared or near infrared light) the area rearward of the vehicle 10 to enhance image capture by the rear camera 14 and/or the rear backup camera in low ambient lighting conditions.

The spare tire bracket 30 (FIGS. 7 and 8) comprises multiple mounting holes 30a to allow for adjustable mounting locations at the rear of the vehicle 10, so as to be able to mount the spare tire bracket 30 at multiple mounting heights for optimizing the wheel/tire position at the rear of the vehicle 10. The spare tire bracket 30 (such as a metal bracket, such as, for example, a steel bracket or the like) also includes multiple camera bracket mounting holes 30b to allow for proper positioning of the camera mounting bracket 28 including the vertically oriented structural arms 28a and the crossbar element 28b at the rear of the vehicle 10 and above the spare tire 24.

Optionally, the vertically oriented structural arms 28a of the camera mounting bracket 28 may comprise telescoping arms to allow for adjustment of the height of the crossbar element 28b without having to remove the spare tire 24. The telescoping arms may include a lower portion that is fastened or attached at the spare tire bracket 30 and an upper end that is adjustably disposed at the lower portion and that is selectively secured at a selected one of a plurality of positions or lengths to allow for positioning of the rear camera 14 at a selected or appropriate height above the spare tire 24. In some implementations, the rear camera 14 may be mounted on distal end of the upper end of the telescoping arms that allows the rear camera 14 to extend or retract relative to the lower portion. The telescoping arms may be secured in the selected length via a pin that extends through both the upper and lower portions (such as a spring-biased pin movably disposed at the inner one of the telescoping arms that is spring-biased or urged outward to engage or be received in one of a plurality of holes along the outer one of the arms), or via any other suitable means, such as a set screw that retains the telescoping arm portions at the selected location or via a clamping element that clamps the upper and lower telescoping arm portions at the selected location or the like.

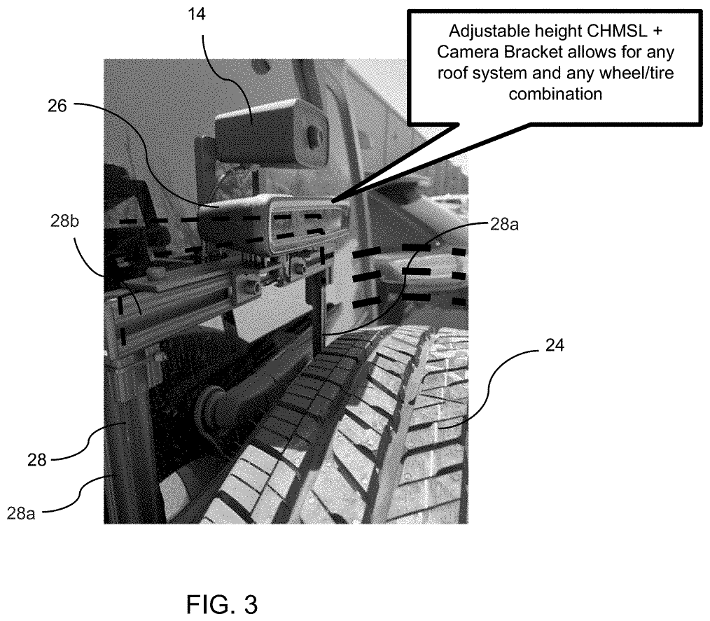

Thus, the present invention provides a CHMSL and camera mount for a CMS rear camera 14 on a vehicle 10 with a removable or changeable top. In some implementations, instead of requiring a CHMSL bracket, the CHMSL is also attached to the mounting bracket 28. The CMS camera 14 is located at or next to the CHMSL (FIG. 7) or just above the CHMSL (FIG. 3). As mentioned above, the camera image stability is critical, and accordingly the camera mounting bracket 28 (and CHMSL mounting bracket) or arm may be made from an aluminum die cast forming process. This formation process thus provides a lightweight robust bracket structure that limits vibration and movement of the rear camera 14 at the upper end of the brackets while the vehicle 10 is driven along a road. To adjust for larger spare tire wheels (which typically may range from a 19 inch diameter to a 36 inch diameter), the mounting bracket 28 and/or CHMSL mounting bracket may be extendable (such as via telescoping arms or the like) to position the rear camera 14 at the appropriate or selected height above the spare tire 24, with a pin or set screw or the like that is used to secure the mounting bracket 28 at the desired degree of extension to maintain the position of the rear camera 14 at the appropriate or selected height. By placing the CMS rear camera 14 at the CHMSL arm and adapting the bracket or arm to be robust and to hold the camera with minimal vibration, consumers would not have to remove the camera or wiring when driving with the hard top on, the soft top on or no top on the vehicle 10.

The rear camera 14 may comprise any suitable imaging sensor or camera, such as a pixelated imaging array or the like, such as a CMOS imaging array sensor, a CCD sensor or other sensors or the like, such as a camera or sensor of the types disclosed in commonly assigned, U.S. Pat. Nos. 7,965,336; 5,550,677; 5,760,962; 6,097,023 and 5,796,094, which are hereby incorporated herein by reference in their entireties. Optionally, the rear camera 14 may comprise a stereo imaging camera or the like, such as by utilizing aspects of the imaging systems described in U.S. Pat. No. 6,396,397, which is hereby incorporated herein by reference in its entirety. Optionally, the rear camera 14 may comprise an infrared or near infrared light sensitive camera and may be suitable for capturing images in low lighting conditions, and/or the rear camera 14 may include or be associated with an illumination source (such as an infrared or near-infrared light emitting illumination source that, when actuated to emit infrared or near-infrared light at the side of the vehicle, enhances the camera's performance but is not visible or discernible to the driver of the vehicle), such as by utilizing aspects of the cameras described in U.S. Pat. Nos. 7,965,336; 5,550,677; 5,760,962; 6,097,023 and 5,796,094, which are hereby incorporated herein by reference in their entireties.

The sideward and rearward viewing cameras may be incorporated at the exterior rearview mirror assembly or elsewhere at the vehicle, such as at a side portion of the vehicle, and having a sideward and rearward field of view. Optionally, the camera may have a wide angle field of view at the side of the vehicle and/or may have an adjustable field of view and/or may capture images for use in other vision systems, such as for use in a top-down view or bird's-eye view vision system of the vehicle or a surround view vision system at the vehicle, such as by utilizing aspects of the vision systems described in U.S. Pat. Nos. 9,126,525; 9,041,806; 9,900,522; 9,900,522; 10,071,687 and/or 9,762,880, and/or U.S. Publication Nos. US-2015-0022664 and/or US-2012-0162427, which are hereby incorporated herein by reference in their entireties.

The mirror assembly may comprise any suitable construction, such as, for example, a mirror assembly with the reflective element being nested in the mirror casing and with a bezel portion that circumscribes a perimeter region of the front surface of the reflective element, or with the mirror casing having a curved or beveled perimeter edge around the reflective element and with no overlap onto the front surface of the reflective element (such as by utilizing aspects of the mirror assemblies described in U.S. Pat. Nos. 7,184,190; 7,274,501; 7,255,451; 7,289,037; 7,360,932; 7,626,749; 8,049,640; 8,277,059 and/or 8,529,108, which are hereby incorporated herein by reference in their entireties) or such as a mirror assembly having a rear substrate of an electro-optic or electrochromic reflective element nested in the mirror casing, and with the front substrate having curved or beveled perimeter edges, or such as a mirror assembly having a prismatic reflective element that is disposed at an outer perimeter edge of the mirror casing and with the prismatic substrate having curved or beveled perimeter edges, such as described in U.S. Pat. Nos. 8,508,831; 8,730,553; 9,598,016 and/or 9,346,403, and/or U.S. Publication Nos. US-2014-0313563 and/or US-2015-0097955, which are hereby incorporated herein by reference in their entireties (and with electrochromic and prismatic mirrors of such construction are commercially available from the assignee of this application under the trade name INFINITY™ mirror).

Optionally, the display may utilize aspects of the displays of the types disclosed in U.S. Pat. Nos. 9,264,672; 9,041,806; 7,855,755; 7,777,611; 7,626,749; 7,581,859; 7,446,924; 7,446,650; 7,370,983; 7,338,177; 7,274,501; 7,255,451; 7,195,381; 7,184,190; 6,690,268; 6,329,925; 5,668,663; 5,530,240 and/or 5,724,187, and/or in U.S. Publication No. US-2006-0050018, which are all hereby incorporated herein by reference in their entireties. The display may be viewable through the reflective element when the display is activated to display information. The display element may be any type of display element, such as a vacuum fluorescent (VF) display element, a light emitting diode (LED) display element, such as an organic light emitting diode (OLED) or an inorganic light emitting diode, an electroluminescent (EL) display element, a liquid crystal display (LCD) element, a video screen display element or backlit thin film transistor (TFT) display element or the like, and may be operable to display various information (as discrete characters, icons or the like, or in a multi-pixel manner) to the driver of the vehicle, such as passenger side inflatable restraint (PSIR) information, tire pressure status, and/or the like.

Changes and modifications to the specifically described embodiments may be carried out without departing from the principles of the present invention, which is intended to be limited only by the scope of the appended claims as interpreted according to the principles of patent law.

1. A vehicular vision system comprising:
an electronic control unit (ECU) at a vehicle equipped with the vehicular vision system, wherein the ECU comprises electronic circuitry and associated software;
a rear camera disposed at the vehicle and having a field of view at least rearward of the vehicle, wherein the rear camera captures image data and captured image data is provided to the ECU;
a video display screen disposed in the vehicle and viewable by a driver of the vehicle, wherein the video display screen is operable to display video images derived from a video signal provided by the ECU during a forward maneuver of the vehicle; and
wherein the rear camera is mounted at a camera mounting bracket that is attached at a spare tire mounting bracket at a rear of the vehicle, and wherein a height of the rear camera is adjustable to position the rear camera above a spare tire mounted at the spare tire mounting bracket.

2. The vehicular vision system of claim 1, wherein the camera mounting bracket is selectively attached at the spare tire mounting bracket to position the rear camera at a selected height above the spare tire mounted at the spare tire mounting bracket.

3. The vehicular vision system of claim 1, wherein the camera mounting bracket is adjustable in length to adjust the height of the rear camera above the spare tire mounted at the spare tire mounting bracket.

4. The vehicular vision system of claim 1, wherein the camera mounting bracket comprises at least one telescoping arm having a lower portion attached at the spare tire mounting bracket and an upper portion that is extendable and retractable relative to the lower portion, and wherein the rear camera is mounted at a distal end of the upper portion that is distal from the lower portion of the at least one telescoping arm.

5. The vehicular vision system of claim 1, wherein a center high-mounted stop light of the vehicle is also attached at the camera mounting bracket.

6. The vehicular vision system of claim 1, wherein a reversing light of the vehicle is also attached at the camera mounting bracket.

7. The vehicular vision system of claim 1, further comprising an auxiliary near infrared light attached at the camera mounting bracket.

8. The vehicular vision system of claim 1, wherein the video display screen is disposed at an interior rearview mirror assembly of the vehicle.

9. The vehicular vision system of claim 8, wherein the video display screen displays the video images at the interior rearview mirror assembly responsive to a user actuatable input that is actuatable by the driver of the vehicle as the vehicle is driven forward along a road.

10. The vehicular vision system of claim 9, further comprising a rear backup camera disposed at the rear of the vehicle below the rear camera, and wherein the video display screen displays rear backup video images derived from image data captured by the rear backup camera during a reversing maneuver of the vehicle.

11. The vehicular vision system of claim 1, further comprising a rear backup camera disposed at the rear of the vehicle below the rear camera, and wherein the video display screen displays rear backup video images derived from image data captured by the rear backup camera during a reversing maneuver of the vehicle.

12. The vehicular vision system of claim 11, wherein the rear backup camera is disposed at a central region of the spare tire mounting bracket and views through a central region of the spare tire mounted at the spare tire mounting bracket.

13. The vehicular vision system of claim 11, wherein the electronic circuitry of the ECU comprises an image processor operable to process image data captured by the rear camera and the rear backup camera.

14. The vehicular vision system of claim 1, wherein the electronic circuitry of the ECU comprises an image processor operable to process image data captured by the rear camera.

15. The vehicular vision system of claim 1, wherein the camera mounting bracket is formed via an aluminum die cast forming process.

16. A vehicular vision system comprising:
a rear camera disposed at a vehicle equipped with the vehicular vision system, wherein the rear camera has a field of view at least rearward of the vehicle, and wherein the rear camera captures image data;
a video display screen disposed at an interior rearview mirror assembly of the vehicle and viewable by a driver of the vehicle, wherein the video display screen is operable to display video images derived from image data captured by the rear camera as the vehicle is driven forward along a road, and wherein the displayed video images are viewable by the driver through a mirror reflective element of the interior rearview mirror assembly;
wherein the video display screen displays the video images at the interior rearview mirror assembly responsive to a user actuatable input that is actuatable by the driver of the vehicle as the vehicle is driven forward along the road; and
wherein the rear camera is mounted at a camera mounting bracket that is attached at a spare tire mounting bracket at a rear of the vehicle, and wherein a height of the rear camera is adjustable to position the rear camera above a spare tire mounted at the spare tire mounting bracket.

17. The vehicular vision system of claim 16, wherein the camera mounting bracket is selectively attached at the spare tire mounting bracket to position the rear camera at a selected height above the spare tire mounted at the spare tire mounting bracket.

18. The vehicular vision system of claim 16, wherein the camera mounting bracket is adjustable in length to adjust the height of the rear camera above the spare tire mounted at the spare tire mounting bracket.

19. The vehicular vision system of claim 16, wherein the camera mounting bracket comprises at least one telescoping arm having a lower portion attached at the spare tire mounting bracket and an upper portion that is extendable and retractable relative to the lower portion, and wherein the rear camera is mounted at a distal end of the upper portion that is distal from the lower portion of the at least one telescoping arm.

20. The vehicular vision system of claim 16, wherein a center high-mounted stop light of the vehicle is also attached at the camera mounting bracket.

21. The vehicular vision system of claim 16, wherein a reversing light of the vehicle is also attached at the camera mounting bracket.

22. The vehicular vision system of claim 16, further comprising an auxiliary near infrared light attached at the camera mounting bracket.

23. The vehicular vision system of claim 16, wherein the camera mounting bracket is formed via an aluminum die cast forming process.

24. A vehicular vision system comprising:
a rear camera disposed at a vehicle equipped with the vehicular vision system, wherein the rear camera has a field of view at least rearward of the vehicle, and wherein the rear camera captures image data;
a video display screen disposed in the vehicle and viewable by a driver of the vehicle, wherein the video display screen is operable to display video images derived from image data captured by the rear camera as the vehicle is driven forward along a road;
wherein the video display screen displays the video images responsive to a user actuatable input that is actuatable by the driver of the vehicle as the vehicle is driven forward along the road;
wherein the rear camera is mounted at a camera mounting bracket that is attached at a spare tire mounting bracket at a rear of the vehicle, and wherein a height of the rear camera is adjustable to position the rear camera above a spare tire mounted at the spare tire mounting bracket; and
wherein the camera mounting bracket is formed via an aluminum die cast forming process.

25. The vehicular vision system of claim 24, wherein the camera mounting bracket is selectively attached at the spare tire mounting bracket to position the rear camera at a selected height above the spare tire mounted at the spare tire mounting bracket.

26. The vehicular vision system of claim 24, wherein the camera mounting bracket is adjustable in length to adjust the height of the rear camera above the spare tire mounted at the spare tire mounting bracket.

27. The vehicular vision system of claim 24, wherein the camera mounting bracket comprises at least one telescoping arm having a lower portion attached at the spare tire mounting bracket and an upper portion that is extendable and retractable relative to the lower portion, and wherein the rear camera is mounted at a distal end of the upper portion that is distal from the lower portion of the at least one telescoping arm.

28. The vehicular vision system of claim 24, wherein a center high-mounted stop light of the vehicle is also attached at the camera mounting bracket.

29. The vehicular vision system of claim 24, wherein a reversing light of the vehicle is also attached at the camera mounting bracket.

30. The vehicular vision system of claim 24, further comprising an auxiliary near infrared light attached at the camera mounting bracket.
